(19) United States
(12) Patent Application Publication
(10) Pub. No.: US 2019/0240815 A1
(43) Pub. Date: Aug. 8, 2019

(54) FINGER TOOL

(71) Applicant: HONDA MOTOR CO., LTD., Tokyo (JP)

(72) Inventors: Kenta Kasano, Tochigi (JP); Masahito Kimori, Tochigi (JP); Yoshinori Tsurugai, Tochigi (JP); Tatsumichi Nakada, Tochigi (JP); Junya Shigeno, Tochigi (JP); Yusuke Miho, Tochigi (JP)

(21) Appl. No.: 16/257,173

(22) Filed: Jan. 25, 2019

(30) Foreign Application Priority Data
Feb. 5, 2018 (JP) 2018-018695

(51) Int. Cl. B25B 21/00

(52) U.S. Cl. CPC B25B 21/002; F16M 13/04

(57) ABSTRACT

A finger tool (10) which tightens a fastening member has a housing (11), a force detector (12), a rotary body (15), and a rotation driving mechanism (13). The force detector (12) is arranged on the housing (11) such that, when the housing (11) is attached to a finger (1) of a person's hand, the force detector (12) contacts a finger underside (2) of the finger (1). The rotary body (15) is arranged such that at least a tip thereof is present outside the housing (11), and has a rotation axis parallel to a specified direction. The rotation driving mechanism (13) is housed in the housing (11) and rotates the rotary body (15) around the rotation axis thereof in the state the housing (11) is attached to the finger (1), in response to detection of a force having a component in the specified direction by the force detector (12).

### BACKGROUND OF THE INVENTION

### Field of the Invention

The present invention relates to a finger tool that is attached to a finger for work.

### Description of the Related Art

Conventionally, when fastening an object to an object with a fastening member, the fastening member is tightened by a tool such as a screwdriver. A general screwdriver has a bit at the tip of a rod, and an operator holds the screwdriver in his or her hand, engages the bit with a cross slot or the like formed in the head of the fastening member, such as a screw, and turns the fastening member to fasten the objects together.

In some work section where the fastening member is placed, the space in the axial direction on the head side of the fastening member is narrow, and it is impossible to enter and use a general rod-shaped screwdriver in the work section. There is known a tool which can be used even in a work section where the space in the axial direction on the head side of the fastening member is narrow (see, for example, Japanese Patent Laid-Open No. 2002-321159).

A conventional tool has a tool body in a ring-like shape which is formed in a ring shape and partly cut off, and a bit which is attached to the tool body and can engage with the head of a fastening member. When using the tool, the tool body is fitted on a finger of the operator in such a manner that the bit is located on the underside of the finger. Since the maximum size of the tool is a size given by adding the height of the bit to the outer diameter of the ring-shaped tool body, even if the working space is a narrow space in the axial direction on the head side of the fastening member, it is possible to tighten the fastening member by entering the finger from a direction perpendicular to the axis of the fastening member, engaging the bit with the head of the fastening member and turning the finger with respect to the axis of the fastening member.

By the way, in some work section, an obstacle such as a wall may also be present in a direction perpendicular to the axis of the fastening member. However, with the conventional tool, it is necessary to turn the finger with respect to the axis of the fastening member, and therefore when an obstacle such as a wall is present in the direction perpendicular to the axis of the fastening member, even if the finger can enter, the fastening member cannot be tightened because the operator cannot turn the finger.

The present invention has been made in consideration of the above aspects, and it is an object of the present invention to provide a finger tool capable of tightening a fastening member such as a bolt even when the work section is such a narrow space that just allows entry of only a finger of a hand as the space in the axial direction on the head side of the fastening member is narrow and also an obstacle is present in a direction perpendicular to the axis of the fastening member.

### SUMMARY OF THE INVENTION

[1] A finger tool of the present invention is characterized by including:

a housing;

a force detector arranged on the housing such that, in a state in which the housing is adapted to be attached to a finger of a hand of a person, the force detector is in contact with the finger;

a rotary body provided in the housing and having a rotation axis parallel to a specified direction; and

a rotation driving mechanism which is housed in the housing, and rotates the rotary body around the rotation axis in the state in which the housing is attached to the finger, according to detection of a force having a component in the specified direction by the force detector.

According to the present invention, when a user (person) attaches the housing of the finger tool to a finger of his or her hand and forces the finger to exert a force having a component in the specified direction onto the force detector from the finger underside in this state, it is possible to rotate the rotary body having the rotation axis parallel to the specified direction. Hence, the user can use the finger tool as if the rotary body is integrated with the finger underside of his or her finger. For example, even when the work field around the head of the fastening member such as a bolt is such a narrow space that just allows entry of only a finger of the hand, it is possible to engage the rotary body with the head and tighten the fastening member.

[2] Preferably, the housing has an attachment section configured to attach the housing to the finger, on a more proximal end side than a first joint of the finger on a distal end side.

According to the present invention, on the distal end side from the first joint of the finger of the hand, the finger is not bound by the attachment section, and therefore the usability of the finger tool for the user can be improved.

[3] The force detector is preferably arranged on the housing such that the force detector is in contact with a finger underside on a more distal end side than the first joint of the finger.

According to the present invention, since the housing is attached through the attachment section to the more proximal end side than the first joint of the finger, the user can easily apply a force to the force detector, which is mounted on the housing, with the finger underside on the more distal end side than the first joint of the finger.

[4] The housing preferably comprises: a first section having a top surface against which a finger underside of the finger abuts when the housing is attached to the finger, and a second section connected to a side of the first section and housing the rotation driving mechanism.

According to the present invention, since the rotation driving mechanism is housed in the second section connected to a side of the first section, the housing can be thinned in the top-to-bottom direction.

[5] The housing preferably has a lateral width corresponding to a width of one finger, and the rotation driving mechanism and a power supply of the rotation driving mechanism are housed in the housing on a press direction side of the finger.

According to the present invention, since the rotation driving mechanism and the power supply which are heavy objects are housed in the housing on the press direction side of the finger, it is easy to handle the finger tool.

### BRIEF DESCRIPTION OF THE DRAWINGS

FIG. 1 is an explanatory view showing a use state of a finger tool according to a first embodiment of the present invention which is attached to a finger;

FIG. 2 is a cross-sectional view of the finger tool of FIG. 1 taken along line II-II;

FIG. 3 is a cross-sectional view of the finger tool of FIG. 2 taken along line III-III;

FIG. 4 is a side view of a finger tool according to a second embodiment of the present invention which is attached to a finger;

FIG. 5 is a cross-sectional view of the finger tool of FIG. 4 taken along line V-V;

FIG. 6 is a cross-sectional view of the finger tool of FIG. 5 taken along line VI-VI;

FIG. 7 is a side view of a finger tool according to a third embodiment of the present invention which is attached to a finger;

FIG. 8 is a cross-sectional view of the finger tool of FIG. 7 taken along line VIII-VIII;

FIG. 9 is a cross-sectional view of the finger tool of FIG. 8 taken along line IX-IX;

FIG. 10 is a cross-sectional view of essential parts of a finger tool according to a fourth embodiment of the present invention; and

FIG. 11 is a cross-sectional view of the finger tool of FIG. 10 taken along line XI-XI.

### DETAILED DESCRIPTION OF THE PREFERRED EMBODIMENTS

### First Embodiment

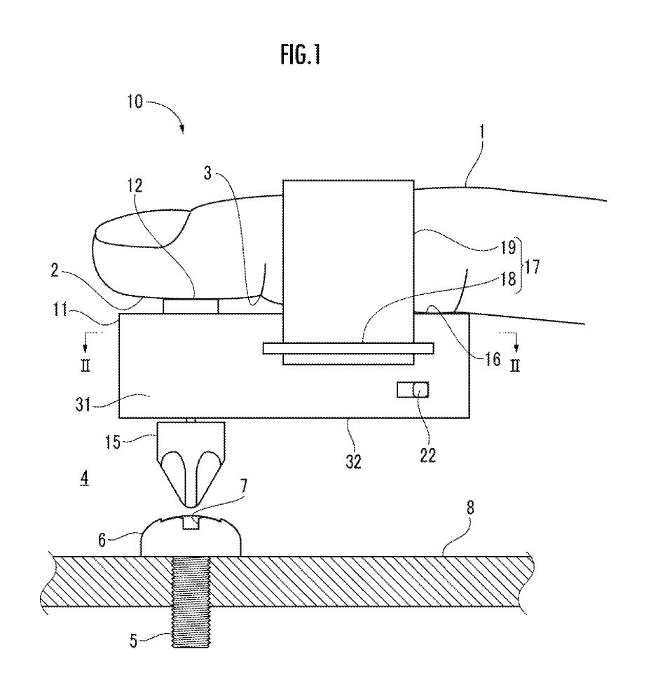

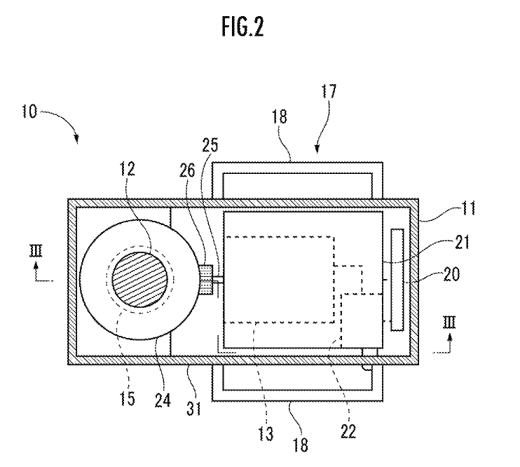

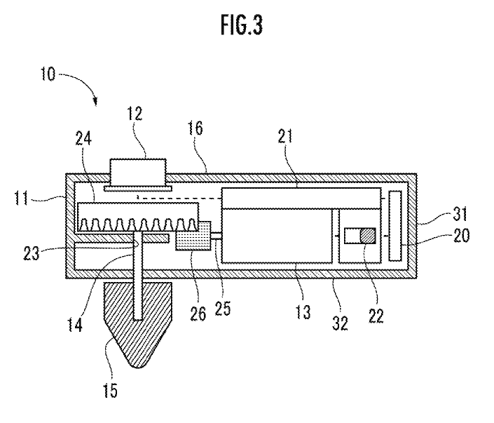

A finger tool 10 according to the first embodiment of the present invention will be described in detail with reference to the drawings. As shown in FIGS. 1 to 3, the finger tool 10 includes: a housing 11 which is attached to a finger underside 2 of a finger 1; a force detector 12 mounted on the housing 11; a rotation driving mechanism (electric motor) 13 that rotates when the force detector 12 detects a force having a component in a specified direction, which is also a component depending on a press direction of the finger, in the state in which the housing 11 is attached to the finger underside 2 of the finger 1; an output shaft 14 that is mounted on the housing 11, outputs the rotation of the rotation driving mechanism 13, and extends in a specified direction; and a rotary body 15 that can be attached to the tip of the output shaft 14. The rotary body 15 may be directly attached to the rotation driving mechanism 13. In this case, a part of the rotary body 15 is housed in the housing 11. The tip portion of the rotary body 15 may protrude to the outside of the housing 11, or may be entirely housed inside the housing 11 in the state in which the rotary body 15 is exposed to the outside through an opening portion of the housing 11. The specified direction coincides with the press direction of the finger, or coincides with a direction in which a component of force caused by pressing with the finger acts.

The housing 11 includes a first section 16 facing the finger underside 2 of the finger 1 (for example, an index finger or a middle finger) of a hand of a person, and an attachment section 17 configured to attach the housing 11 to the finger 1, on the more proximal end side than a first joint 3 of the finger 1 on the distal end side. The attachment section 17 has an attachment support part 18 formed in the housing 11, and a rubber band 19 attached to the attachment support part 18. The force detector 12 is arranged on the more distal end side than the first joint 3 of the finger 1.

The finger tool 10 also includes: a power supply 21, such as a battery, a secondary battery or cell, which is installed in the housing 11 to supply power to the rotation driving mechanism 13; a changeover switch 22 which is installed in the housing 11 to switch the rotation driving mechanism 13 among forward rotation, reverse rotation and stop; and a control unit 20 which controls the supply of power from the power supply 21 to the rotation driving mechanism 13 by a signal of ON or OFF of the force detector 12.

The output shaft 14 is rotatably supported by a bearing 23 of the housing 11. The rotary body 15 is mounted on one end of the output shaft 14, and a first gear 24 is mounted on the other end of the output shaft 14. A second gear 26 which meshes with the first gear 24 is mounted on a rotating shaft 25 of the rotation driving mechanism 13.

### (Arrangement of Components in Internal Space of Housing 11)

The housing 11 has a hollow substantially rectangular parallelepiped shape, and includes the first section 16, a side wall section 31 connected to an edge of the first section 16, and a bottom section 32 connected to a lower edge of the side wall section 31.

In the case where the first section 16 (ceiling section) is the upper side and the bottom section 32 is the lower side, the power supply 21 is arranged under the proximal end side of the first section 16, the changeover switch 22 is arranged under the proximal end side of the power supply 21, and the rotation driving mechanism 13 is arranged under the distal end side of the power supply 21. The first gear 24 is arranged in front of the rotation driving mechanism 13 and under the force detector 12, and the rotary body 15 is arranged under the first gear 24 and on the outside of the bottom section 32.

### (Function of Finger Tool 10)

The finger tool 10 attached to the finger 1 is moved to a work section 4, and the rotary body 15 is engaged with a cross slot 7 provided on a head 6 of a fastening member 5. The force detector 12 is pressed with the finger underside 2 of the finger 1 to rotate the rotary body 15 and fasten the fastening member 5 to a target member 8 to be fastened. The housing 11 may also be attached to the finger 1 after modifying the configuration of the attachment section 17 such that the force detector 12 is pressed by a part of the finger 1 different from the finger underside 2, such as the top side or a lateral side of the finger 1.

In the state in which the housing 11 is attached to the finger underside 2 of the finger 1, when the finger underside 2 of the finger 1 applies a force to the finger tool 10 to cause the force detector 12 to detect a force having a component in a specified direction, it is possible to rotate the output shaft 14 extending parallel to the specified direction. Hence, with the use of the finger tool 10 while feeling as if the output shaft 14 is integrated with the finger underside 2 of the finger 1, work can be done by just applying a force to the finger underside 2 of the finger 1. Even if the work section 4 is such a narrow space that just allows an entry of only the finger 1 of the hand as the space in the axial direction on the head 6 side of the fastening member 5 is narrow and also an obstacle is present in a direction perpendicular to the axis of the fastening member 5, the fastening member 5 such as a bolt can be tightened.

Moreover, by having the attachment section 17 on the more proximal end side than the first joint 3 on the distal end side of the finger 1 to which the finger tool 10 is attached, it is possible to free the fingers other than the finger 1 to which the finger tool 10 is attached. In addition, a force can be applied in a state in which the finger 1 floats over the force detector 12, or the finger 1 is pressed against the fastening member 5 (object).

In the above-described embodiment, the rotary body 15 is a bit corresponding to a Philips-head screw, but the rotary body 15 is not limited to this, and can be other bit corresponding to a general fastening member 5, such as a flat-head screw, bolt, hexagon bolt, etc., as long as the bit is capable of tightening the fastening member 5 by turning. Further, other than the bit corresponding to the fastening member 5, the rotary body 15 may be a bit that is a rotary tool, such as a polishing tool like a rotary file, a brush, etc. Furthermore, in the above-described embodiment, the force detector 12 is a button type connection switch that switches between ON and OFF, but the force detector 12 is not limited to this and may be a touch type connection switch that detects a contact of the finger underside 2 of the finger 1, or a sensor type connection switch that turns ON when a pressure equal to or greater than a predetermined value is detected.

In the above-described embodiment, a combination of the first gear 24 and the second gear 26 is used, but as long as the driving force of the rotation driving mechanism 13 is transmitted, there is no requirement for gear types, such as a combination of bevel gears.

### Second Embodiment

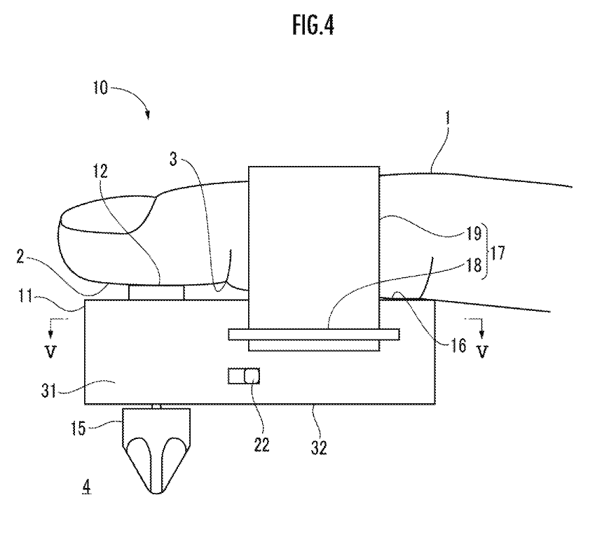

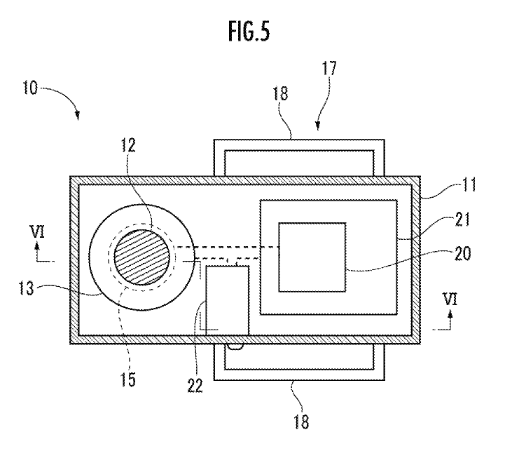

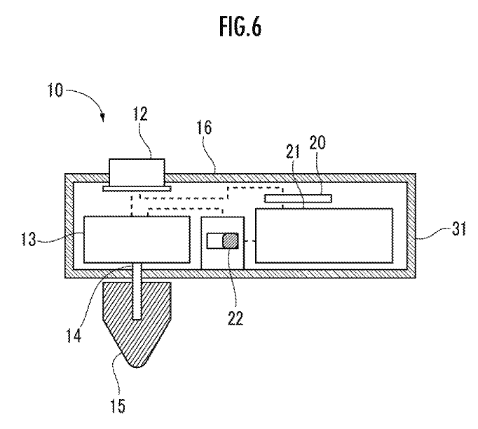

Next, the second embodiment of the present invention will be described. For the same configurations as those of the first embodiment, descriptions will be omitted, and the same reference signs will be used. As shown in FIGS. 4 to 6, the finger tool 10 includes the housing 11, the force detector 12, the rotation driving mechanism 13, the output shaft 14, the rotary body 15, the control unit 20, the power supply 21 such as a battery, a secondary battery or a cell, and the changeover switch 22.

The housing 11 has the attachment section 17 on the more proximal end side than the first joint 3 on the distal end side of the finger 1 to which the finger tool 10 is attached, and the force detector 12 is arranged on the more distal end side than the first joint 3 of the finger 1 to which the finger tool 10 is attached. The output shaft 14 is directly mounted on the rotation driving mechanism 13, and the rotary body 15 is mounted on the output shaft 14. Therefore, it is unnecessary to provide gears, and it is possible to simplify the configuration of the finger tool 10 and achieve downsizing.

Next, the arrangement inside the housing 11 will be described. The housing 11 has a substantially rectangular parallelepiped shape, and includes the first section 16, the side wall section 31 connected to an edge of the first section 16, and the bottom section 32 connected to the lower edge of the side wall section 31.

In the case where the first section 16 is the upper side and the bottom section 32 is the lower side, the power supply 21 is arranged under the proximal end side of the first section 16, the changeover switch 22 is arranged in front of the power supply 21, and the rotation driving mechanism 13 is arranged in front of the changeover switch 22. The rotation driving mechanism 13 is arranged right below the force detector 12, the rotary body 15 is arranged right below the rotation driving mechanism 13, and the force detector 12, the rotation driving mechanism 13 and the rotary body 15 are arranged in a row in the top-to-bottom direction. Hence, when the force detector 12 is pressed with the finger underside 2 of the finger 1, a force in the specified direction of the finger 1 can be transmitted to the rotary body 15 in a row.

A lateral width W of the housing 11 has a width corresponding to the width of one finger, and the rotation driving mechanism 13 and the power supply 21 of the rotation driving mechanism 13 are housed in the housing 11 on a press direction side of the finger 1 (which is the lower side of the finger 1 when the housing 11 is positioned on the lower side of the finger 1, or is the right side of the finger 1 when the housing 11 is positioned on the right side of the finger 1). Thus, by housing the rotation driving mechanism 13 and the power supply 21, which are heavy objects, in the housing 11 on the press direction side of the finger 1, the finger tool 10 can be easily handled.

### Third Embodiment

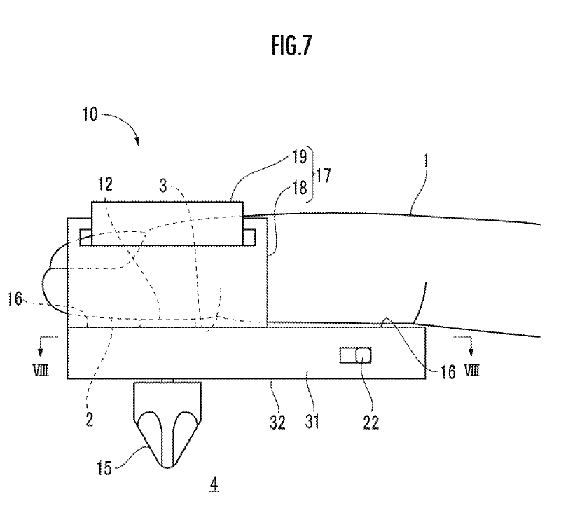

Next, the third embodiment of the present invention will be described. For the same configurations as those of the first embodiment, descriptions will be omitted, and the same reference signs will be used. As shown in FIGS. 7 to 9, the finger tool 10 includes the housing 11, the force detector 12, the rotation driving mechanism 13, the rotating shaft 25, the second gear 26, a spur gear 27, the output shaft 14, the rotary body 15, the control unit 20, the power supply (hereinafter referred to as the battery) 21, and the changeover switch 22.

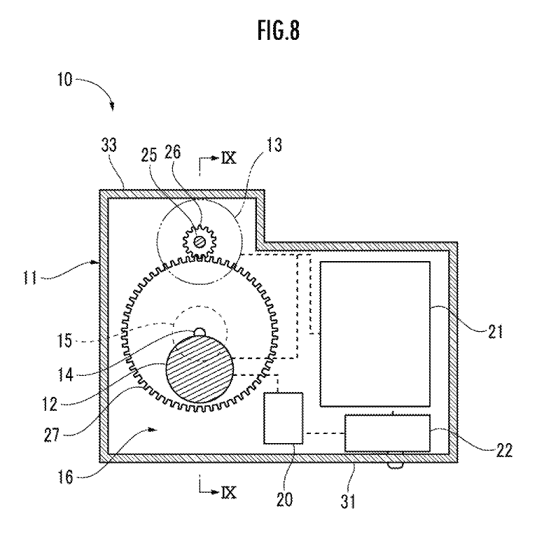

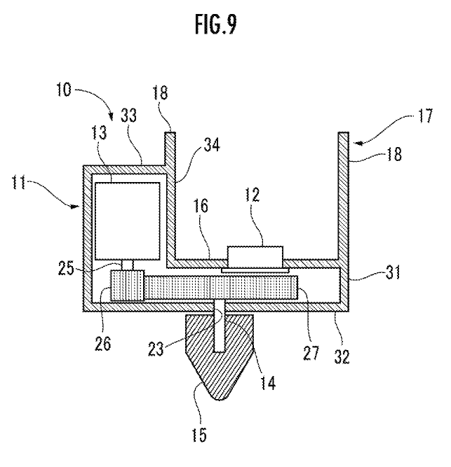

Next, the shape of the housing 11 will be described. The housing 11 comprises: the first section 16 on which the finger 1 is placed; a second section 33 which is arranged at a position shifted to a side of the finger 1 from the first section 16 and houses the rotation driving mechanism 13; the side wall section 31 connected to an edge of the first section 16; and the bottom section 32 connected to the lower edge of the side wall section 31. In the plan view shown in FIG. 8 and the front view shown in FIG. 9, the outline of the housing 11 is substantially L-shaped.

The attachment section 17 is mounted on the distal end side of the housing 11, one attachment support part 18 is provided to extend from the side wall 34 of the second section 33 on the first section 16 side, and another attachment support part 18 is provided to extend in a vertical direction of the first section 16 so that the another attachment support part 18 rises from the edge of the first section 16 on the opposite side to the second section 33 side. In the state in which the finger 1 is attached, the first joint 3 of the finger 1 is at the position of the attachment section 17 in a side view.

Next, the arrangement inside the housing 11 will be described. The rotation driving mechanism 13 is housed in the second section 33 located at a position shifted laterally from the first section 16, the rotation driving mechanism 13 is arranged vertically so that the rotating shaft 25 is parallel to the output shaft 14, the second gear 26 is mounted on the lower end of the rotating shaft 25 extending downward from the rotation driving mechanism 13, the spur gear 27 is located downward of the rotation driving mechanism 13 and also downward of the force detector 12, and the power supply 21 and the changeover switch 22 are arranged under the first section 16 on the proximal end side to be the same height as the spur gear 27.

Since the rotation driving mechanism 13 is arranged at a position shifted laterally from the first section 16 on which the finger 1 is placed, the housing 11 can be thinned.

### Fourth Embodiment

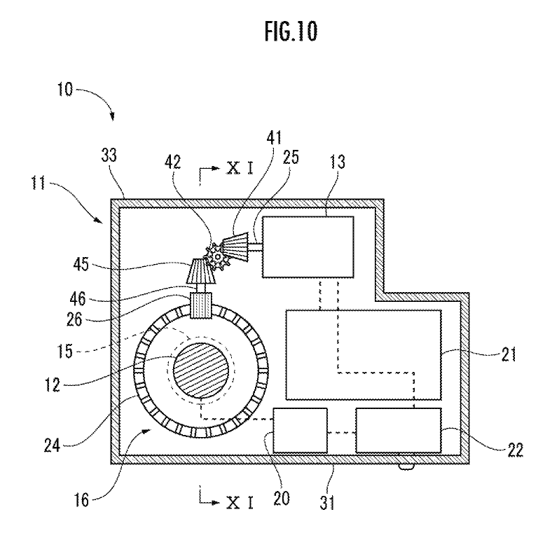

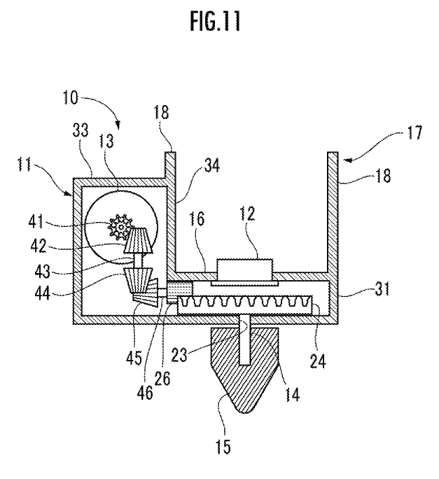

Next, the fourth embodiment of the present invention will be described. For the same configurations as those of the first embodiment, descriptions will be omitted, and the same reference signs will be used. As shown in FIGS. 10 to 11, the finger tool 10 includes the housing 11, the force detector 12, the rotation driving mechanism 13, the rotating shaft 25, a first bevel gear 41, a second bevel gear 42, a first intermediate shaft 43, a third bevel gear 44, a fourth bevel gear 45, a second intermediate shaft 46, the second gear 26, the first gear 24, the output shaft 14, the rotary body 15, the control unit 20, the power supply 21, and the changeover switch 22.

The first bevel gear 41 is mounted on the distal end of the rotating shaft 25, the second bevel gear 42 is arranged to mesh with the first bevel gear 41 and mounted on one end of the first intermediate shaft 43 which is rotatably supported by a support part (not shown), the third bevel gear 44 is mounted on the other end of the first intermediate shaft 43, the fourth bevel gear 45 is arranged to mesh with the third bevel gear 44, the fourth bevel gear 45 is mounted on one end of the second intermediate shaft 46 rotatably supported by a support part (not shown), the second gear 26 is mounted on the other end of the second intermediate shaft 46, the first gear 24 is arranged to mesh with the second gear 26, the first gear 24 is mounted on one end of the output shaft 14 rotatably supported by the bearing 23, and the rotary body 15 is mounted on the other end of the output shaft 14.

Next, the arrangement inside the housing 11 will be described. The rotation driving mechanism 13 is housed in the second section 33 located at a position shifted laterally from the first section 16, the rotation driving mechanism 13 is arranged sideways so that the rotating shaft 25 is perpendicular to the output shaft 14, the first intermediate shaft 43 is arranged parallel to the output shaft 14, the second intermediate shaft 46 is arranged parallel to the rotating shaft 25, the first gear 24 is located downward of the rotation driving mechanism 13 and also downward of the force detector 12, and the power supply 21 and the changeover switch 22 are arranged under the first section 16 on the proximal end side to be the same height as the first gear 24.

Since the rotation driving mechanism 13 is arranged at a position shifted laterally from the first section 16 on which the finger 1 is placed, the housing 11 can be thinned.

In the above-described embodiments, the rotary body 15 is a Philips-head screwdriver, but the rotary body 15 is not limited to this, and may be a detachable rotary body 15, such as a flat-head screwdriver and a hexagon wrench, which can engage with the fastening member 5. Moreover, the position of the attachment section 17 is not limited to the positions in the embodiments, and the position where the attachment section 17 is provided in the housing 11 does not matter, and can be the distal end side, the middle, or the proximal end side of the housing 11. Further, in the embodiments, the rotation driving mechanism 13 is the electric motor, but the rotation driving mechanism 13 is not limited to this, and may be a rotating spring or the like that rotates when the force detector 12 is pressed.

What is claimed is:

1. A finger tool comprising:
a housing;
a force detector arranged on the housing such that, in a state in which the housing is adapted to be attached to a finger of a hand of a person, the force detector is in contact with the finger;
a rotary body provided in the housing and having a rotation axis parallel to a specified direction; and
a rotation driving mechanism which is housed in the housing, and rotates the rotary body around the rotation axis in the state in which the housing is attached to the finger, according to detection of a force having a component in the specified direction by the force detector.

2. The finger tool according to claim 1, wherein
the housing has an attachment section configured to attach the housing to the finger, on a more proximal end side than a first joint of the finger on a distal end side.

3. The finger tool according to claim 2, wherein
the force detector is arranged on the housing such that the force detector is in contact with a finger underside on a more distal end side than the first joint of the finger.

4. The finger tool according to claim 2, wherein
the housing comprises:
a first section having a top surface against which a finger underside of the finger abuts when the housing is attached to the finger, and
a second section connected to a side of the first section and housing the rotation driving mechanism.

5. The finger tool according to claim 2, wherein
the housing has a lateral width corresponding to a width of one finger, and
the rotation driving mechanism and a power supply of the rotation driving mechanism are housed in the housing on a press direction side of the finger.
